(19) United States
(12) Patent Application Publication
(10) Pub. No.: US 2018/0037205 A1
(43) Pub. Date: Feb. 8, 2018

(54) VEHICLE REGENERATIVE AIR BRAKE SYSTEM

(71) Applicant: FORD GLOBAL TECHNOLOGIES, LLC, Dearborn, MI (US)

(72) Inventors: Jose Leopoldo Contreras, Mexico City (MX); Rodrigo Felix, Estado de Mexico (MX)

(21) Appl. No.: 15/226,279

(22) Filed: Aug. 2, 2016

(51) Int. Cl. B60T 13/58; B60T 1/16

(52) U.S. Cl. CPC B60T 13/585; B60T 1/16

(57) ABSTRACT

A vehicle includes a vehicle body and a regenerative air brake system disposed inside the vehicle body. The regenerative air brake system includes a conduit, a turbine positioned in the conduit, and an electrical generator operatively connected to the turbine and positioned remotely from the conduit. The regenerative air brake system may be activated during vehicle braking events to assist in decelerating the moving vehicle.

### TECHNICAL FIELD

This disclosure relates to a regenerative air brake system for a vehicle. The regenerative air brake system may be selectively employed to reduce the load on the vehicle's friction braking system and increase the amount of energy that can be reclaimed during vehicle deceleration.

### BACKGROUND

The need to improve the energy efficiency of automotive vehicles has been well documented. Efforts have therefore been undertaken to reclaim energy that would otherwise be lost to the environment as waste heat during vehicle operation. For example, regenerative braking systems are known that reclaim energy through braking by repurposing an electric motor as an electric generator. However, these systems typically lack effectiveness during sudden braking conditions at high speeds.

### SUMMARY

A vehicle according to an exemplary aspect of the present disclosure includes, among other things, a vehicle body and a regenerative air brake system disposed inside the vehicle body. The regenerative air brake system includes a conduit, a turbine positioned in the conduit, and an electrical generator operatively connected to the turbine and positioned remotely from the conduit.

In a further non-limiting embodiment of the foregoing vehicle, the conduit includes an inlet at a front of the vehicle body and an outlet at a rear of the vehicle body.

In a further non-limiting embodiment of any of the foregoing vehicles, the conduit at least partially extends through an engine compartment of the vehicle body.

In a further non-limiting embodiment of any of the foregoing vehicles, the conduit at least partially extends through a chassis of the vehicle body.

In a further non-limiting embodiment of any of the foregoing vehicles, the conduit includes a branch having an inlet, and a door is movable to open and close the inlet.

In a further non-limiting embodiment of any of the foregoing vehicles, the inlet is located near a wheel well of the vehicle body.

A further non-limiting embodiment of any of the foregoing vehicles includes an actuator configured to move the door between a first position and a second position to open and close the inlet.

In a further non-limiting embodiment of any of the foregoing vehicles, the conduit includes a first branch having a first inlet and a second branch having a second inlet, and the first branch and the second branch meet at a junction of the conduit. The junction is upstream from the turbine.

In a further non-limiting embodiment of any of the foregoing vehicles, the turbine includes a stator and a rotor.

In a further non-limiting embodiment of any of the foregoing vehicles, the electrical generator feeds electricity to an electrical system of the vehicle.

A further non-limiting embodiment of any of the foregoing vehicles includes a friction braking system. The regenerative air brake system and the friction braking system cooperate to decelerate the vehicle.

A further non-limiting embodiment of any of the foregoing vehicles includes a control system adapted to activate the regenerative air brake system during vehicle deceleration.

A method according to an exemplary aspect of the present disclosure includes, among other things, activating a regenerative air brake system of a moving vehicle during vehicle braking events to assist in decelerating the moving vehicle.

A further non-limiting embodiment of the foregoing method includes activating the regenerative air brake system if a requested deceleration rate exceeds a threshold deceleration rate.

A further non-limiting embodiment of any of the foregoing methods includes activating the regenerative air brake system if a current vehicle speed exceeds a threshold vehicle speed.

A further non-limiting embodiment of any of the foregoing methods includes activating the regenerative air brake system if an inferred amount of airflow passing through the regenerative air brake system exceeds a threshold amount of airflow.

In a further non-limiting embodiment of any of the foregoing methods, the vehicle braking events occur when a friction braking system of the moving vehicle has been activated.

A further non-limiting embodiment of any of the foregoing methods includes utilizing a turbine to extract energy from airflow communicated through a conduit of the regenerative air brake system, and powering an electrical generator using the energy extracted from the airflow.

A further non-limiting embodiment of any of the foregoing methods includes opening a door at an inlet of the conduit to allow the airflow to enter the conduit.

A further non-limiting embodiment of any of the foregoing methods includes deactivating the regenerative air brake system during non-braking events.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates a vehicle.

FIG. 2 schematically illustrates a regenerative air brake system of a vehicle.

FIG. 3 schematically illustrates a regenerative air brake system according to another embodiment of this disclosure.

FIG. 4 schematically illustrates a regenerative air brake system according to yet another embodiment of this disclosure.

FIG. 5 schematically illustrates an exemplary control strategy for controlling a regenerative air brake system of a vehicle.

### DETAILED DESCRIPTION

This disclosure describes a vehicle regenerative air brake system. The regenerative air brake system includes a conduit, a turbine positioned in the conduit, and an electrical generator operatively connected to the turbine. The regenerative air brake system is selectively activated to reclaim energy during braking events, assist in decelerating the moving vehicle, or both. In some embodiments, the regenerative air brake system is automatically activated in response to actuating a friction braking system of the vehicle. These and other features are discussed in greater detail in the following paragraphs of this detailed description.

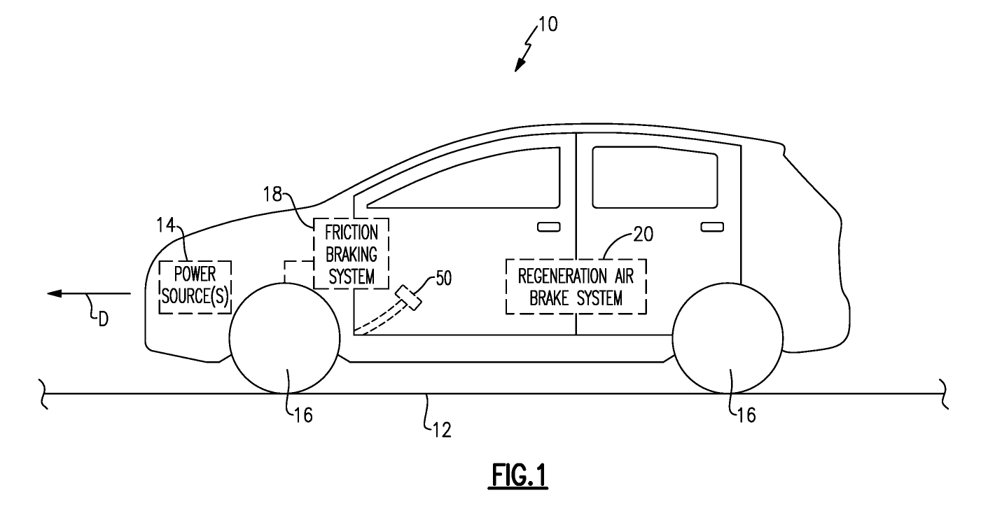

FIG. 1 schematically illustrates a vehicle 10 traveling in a direction D along a roadway 12. Although an exemplary component relationship of the vehicle 10 is illustrated in FIG. 1, this illustration is highly schematic and is not intended to limit this disclosure. In other words, the placement and orientation of the various components of the vehicle 10 could vary from vehicle to vehicle.

The vehicle 10 could include a traditional drivetrain or an electrified drivetrain. In addition, the vehicle 10 is depicted in this non-limiting embodiment as a car. However, trucks, cars, vans, or any other type of automotive vehicles could also benefit from the teachings of this disclosure.

The exemplary vehicle 10 includes a powertrain having one or more power sources 14. In a first non-limiting embodiment, the power source 14 is an engine if the vehicle 10 includes a traditional drivetrain. In another non-limiting embodiment, the power source 14 is an electric machine (i.e., an electric motor, generator, or combined motor/generator) if the vehicle 10 includes an electrified drivetrain. In yet another non-limiting embodiment, the power source 14 includes both an engine and an electric machine if the vehicle 10 includes a hybrid drivetrain. The power source(s) 14 generate torque to drive one or more sets of drive wheels 16 of the vehicle 10.

The vehicle 10 includes a friction braking system 18 for decelerating the drive wheels 16 in order to bring the vehicle 10 to a stop, or to arrest its motion. For example, the friction braking system 18 may operate to slow the speed of the drive wheels 16 by applying one or more friction elements (e.g., brake pads, shoes, etc., not shown in schematic depiction of FIG. 1). Application of the friction elements converts the kinetic energy of the moving drive wheels 16 into heat to inhibit motion of the vehicle 10. The friction braking system 18 is activated by depressing a brake pedal 50 located within the passenger compartment of the vehicle 10. The brake pedal 50 is typically depressed by an operator's foot in order to activate the friction braking system 18 and decelerate the vehicle 10. Although not shown, the vehicle 10 could additionally include a regenerative engine braking system.

The vehicle 10 is additionally equipped with a regenerative air brake system 20. The regenerative air brake system 20 may be used in combination with the friction braking system 18 to decelerate the vehicle 10. In a non-limiting embodiment, the regenerative air brake system 20 generates electricity during braking events by reclaiming energy from airflow that passes through the vehicle 10. Various exemplary regenerative air brake systems are discussed in greater detail below.

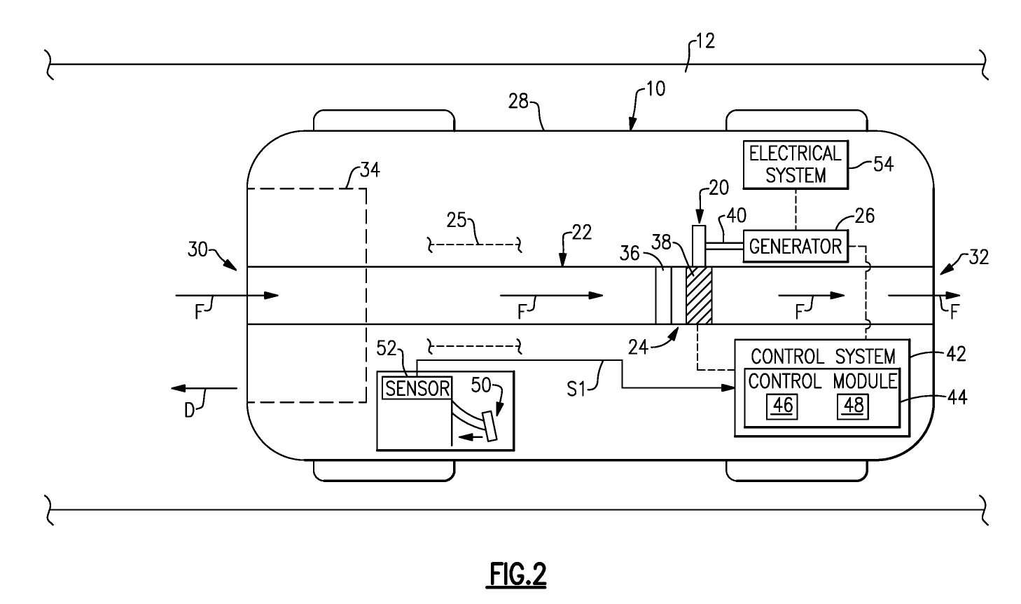

FIG. 2 details an exemplary regenerative air brake system 20. The regenerative air brake system 20 could be employed within the vehicle 10 of FIG. 1 or any other vehicle. In a non-limiting embodiment, the regenerative air brake system 20 includes a conduit 22, a turbine 24, and an electrical generator 26.

The conduit 22 establishes a hollow passage that extends entirely or partially through the vehicle 10. The conduit 22 is positioned inside a vehicle body 28, or structural frame, of the vehicle 10. The conduit 22 is considered “inside” the vehicle body 28 in that it is not mounted to an exterior portion of the vehicle 10 but instead is an internal component of the vehicle 10. In a non-limiting embodiment, portions of the conduit 22 pass through hollow sections of a chassis 25 of the vehicle 10. In another non-limiting embodiment, portions of the conduit 22 extend through an engine compartment 34 of the vehicle 10.

The conduit 22 includes an inlet 30 and an outlet 32. An airflow F may enter the conduit 22 through the inlet 30 and may be expelled from the conduit 22 through the outlet 32. In a non-limiting embodiment, the inlet 30 is disposed at a front of the vehicle body 28, whereas the outlet 32 is disposed at a rear of the vehicle body 28. The exact conduit design shown in FIG. 2 is not intended to be limiting, and it should be understood that other configurations are contemplated within the scope of this disclosure.

The turbine 24 is mounted within the conduit 22 at a location between the inlet 30 and the outlet 32. The exact mounting location of the turbine 24 can vary depending on various design aspects associated with the vehicle 10, including but not limited to the amount of airflow F that is permitted to pass through the conduit 22. The turbine 24 includes a stator 36 and a rotor 38. The stator 36 is a stationary component and the rotor 38 is a movable component. For example, the stator 36 controls the speed and direction of the airflow F as it is communicated through the conduit 22 toward the rotor 38, and the rotor 38 rotates to extract work (i.e., energy) from the airflow F.

The electrical generator 26 is operably connected to the turbine 24, and in particular to the rotor 38, via a drive shaft 40. The energy extracted from the airflow F by the rotor 38 drives the electrical generator 26 to generate electricity which can be fed back into an electrical system 54 of the vehicle 10, for example. In a non-limiting embodiment, the electrical generator 26 is mounted at a location remote from the conduit 22. Stated another way, unlike the turbine 24, the electrical generator 26 is not mounted within the conduit 22.

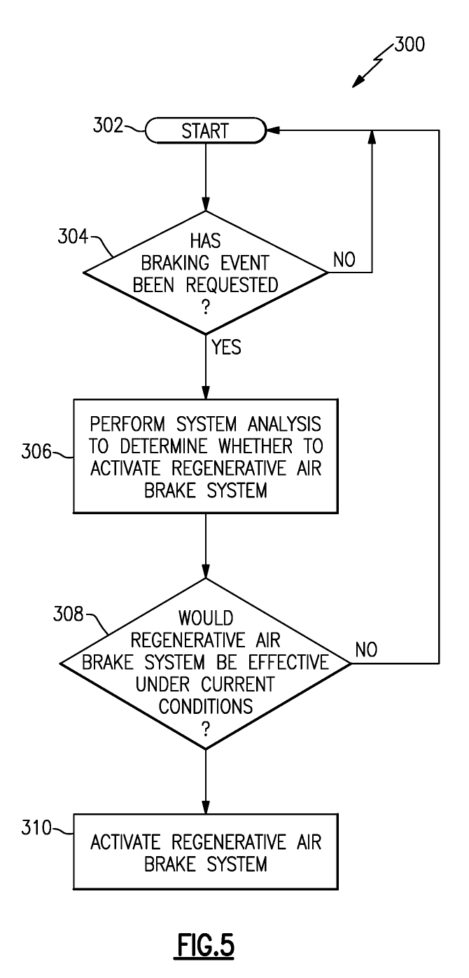

A control system 42 is adapted to control activation and deactivation of the regenerative air brake system 20 during movement of the vehicle 10 in the direction D along the roadway 12. The control system 42 could be part of an overall vehicle system controller (VSC) or could be a separate control system that communicates with the VSC. The control system 42 includes one or more control modules 44 equipped with executable instructions for interfacing with and commanding operation of various components of the regenerative air brake system 20. In another non-limiting embodiment, each control module 44 of the control system 42 includes a processing unit 46 and non-transitory memory 48 for executing the various control strategies and modes of the regenerative air brake system 20. One exemplary control strategy of the regenerative air brake system 20 is discussed below with reference to FIG. 5.

In a non-limiting embodiment, the control system 42 is adapted to activate the regenerative air brake system 20 if the friction braking system 18 (see FIG. 1) of the vehicle 10 has been activated. This may be referred to as a braking event. In a non-limiting embodiment, the control system 42 monitors a position of the brake pedal 50 to determine whether or not the friction braking system 18 has been activated. The brake pedal 50 may be selectively depressed by a driver to decelerate the vehicle 10 using the friction braking system 18. The brake pedal 50 may be an electronic device that includes a sensor 52 for indicating a pedal position when the brake pedal 50 is actuated. The sensor 52 may generate a pedal position signal S1 that is communicated to the control system 42 as pressure is applied to the brake pedal 50. The pedal position signal S1 is indicative of an amount of pressure applied to the brake pedal 50, and may be used by the control system 42 to determine whether or not to activate the regenerative air brake system 20 in order to augment decelerating the vehicle 10. Additional exemplary functions of the control system 42 include monitoring the current speed of the vehicle 10, estimating the amount of airflow F passing through the conduit 22 of the regenerative air brake system 20, etc.

When the regenerative air brake system 20 is activated, airflow F is communicated freely through the conduit 22 to the turbine 24. The airflow F passing through the turbine 24 exerts a force on the turbine 24 which arrests movement of the vehicle 10 via increased drag. Thus, in a non-limiting embodiment, the regenerative air brake system 20 acts as an aeronautical air brake to aid in decelerating the vehicle 10.

The airflow F passing through the conduit 22 eventually passes through the turbine 24. Since the airflow F typically passes though the conduit 22 at constant subsonic speeds and therefore behaves like an incompressible flow, the stator 36 of the turbine 24 may be provided to modify the properties (speed, temperature, direction, etc.) of the airflow F so additional work can be extracted from the airflow F by the rotor 38. The energy extracted from the airflow F by the rotor 38 is used to power the electrical generator 26 for generating electricity.

The energy reclaimed from the airflow F during vehicle deceleration can be used for various purposes. For example, in a vehicle powered solely by an internal combustion engine, the reclaimed energy can be used to reduce the load on the alternator and reduce fuel consumption of the engine. In an alternative embodiment, such as for hybrid and all-electric vehicles, the reclaimed energy can be used to power various components of the vehicle, or can be used to aid vehicle propulsion, thus increasing available energy and overall vehicle efficiencies.

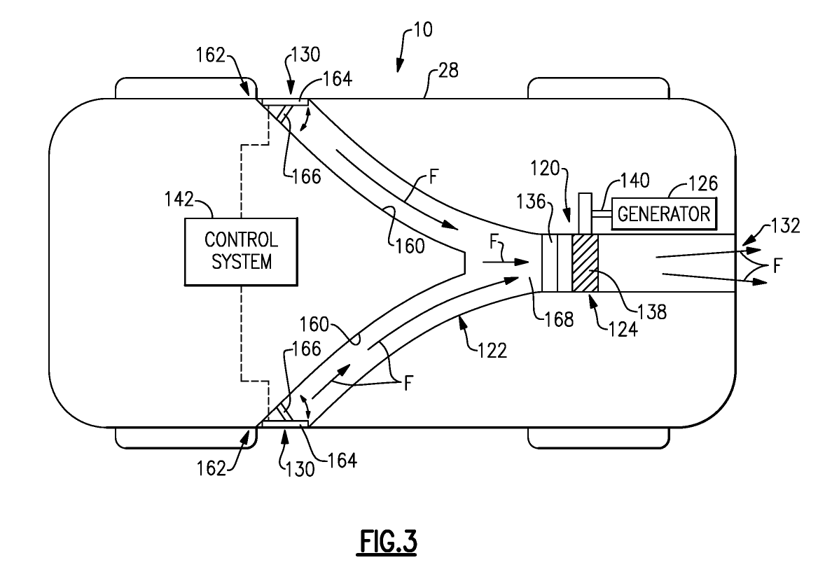

FIG. 3 illustrates another exemplary regenerative air brake system 120. The regenerative air brake system 120 is similar to the regenerative air brake system 20 of FIG. 2 but includes a slightly modified conduit 122 for directing airflow F through the regenerative air brake system 120. The distinctions between the non-limiting embodiments of FIGS. 2 and 3 should become apparent in view of the following details of the regenerative air brake system 120.

In a non-limiting embodiment, the regenerative air brake system 120 includes a conduit 122, a turbine 124, and an electrical generator 126. The conduit 122 is positioned inside a vehicle body 28 of the vehicle 10 and includes multiple branches 160 that direct the airflow F toward the turbine 124. Although two branches 160 are shown in FIG. 3, the conduit 122 could include any number of branches.

Each branch 160 establishes an inlet 130 for directing the airflow F into the conduit 122. In a non-limiting embodiment, the inlets 130 are positioned near wheel wells 162 of the vehicle 10, although other inlet locations are also contemplated. A door 164 may be selectively moved to open or close the inlet 130. Each door 164 includes an actuator 166 for moving the door 164 between the closed and open positions. The actuator 166 could include a mechanical device, an electrical device, or any other actuating device capable of moving the door 164 to open and close the inlet 130.

The conduit 122 further includes an outlet 132. The airflow F may be expelled from the conduit 122 through the outlet 132 after energy has been extracted from the airflow F by the turbine 124. In a non-limiting embodiment, the outlet 132 is disposed at a rear of the vehicle body 28. However, other outlet locations are also contemplated within the scope of this disclosure.

Airflow F entering into each branch 160 mixes with airflow F from other branches at a junction 168 prior to passing to the turbine 124. The turbine 124 may be mounted at any location downstream from the junction 168.

The turbine 124 includes a stator 136 and a rotor 138. The stator 136 controls the speed and direction of the airflow F as it is communicated through the conduit 122 toward the rotor 138, and the rotor 138 rotates to extract energy from the airflow F.

The electrical generator 126 is operably connected to rotor 138 via a drive shaft 140. The energy extracted from the airflow F by the rotor 138 drives the electrical generator 126 for generating electricity. Energy is thus reclaimed during vehicle deceleration and can be used to power various vehicle loads.

A control system 142 of the regenerative air brake system 120 is adapted to activate/deactivate the regenerative air brake system 120. In a non-limiting embodiment, the control system 142 activates the regenerative air brake system 120 if the friction braking system 18 (see FIG. 1) of the vehicle 10 has been activated and deactivates the regenerative air brake system 120 if the friction braking system 18 has been deactivated. For example, if the friction braking system 18 is activated, the control system 142 commands the actuators 166 to move the doors 164 to an open position, thus allowing airflow F to enter into the inlets 130 of the branches 160. The airflow F entering the conduit 122 eventually passes through the turbine 124, thus exerting a force on the turbine 124 which arrests movement of the vehicle 10 via increased drag. In addition, the energy extracted from the airflow F by the rotor 138 may be used to generate electricity within the electrical generator 126. The control system 142 commands the actuators 166 to move the doors 164 to a closed position, thus closing off the inlets 130, once the friction braking system 18 has been deactivated.

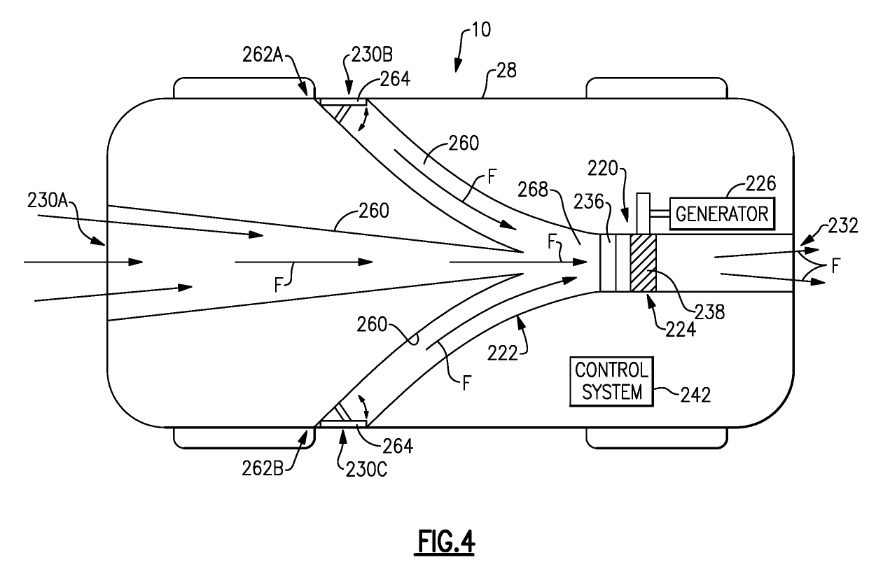

FIG. 4 illustrates yet another exemplary regenerative air brake system 220. In a non-limiting embodiment, the regenerative air brake system 220 includes a conduit 222, a turbine 224, and an electrical generator 226. The conduit 222 is positioned inside a vehicle body 28 of the vehicle 10 and includes multiple branches 260 that direct the airflow F toward the turbine 224. Each branch 260 includes an inlet for directing the airflow F into the conduit 222. In a non-limiting embodiment, a first inlet 230A is positioned at a front of the vehicle body 28, a second inlet 230B is positioned near a first wheel well 262A of the vehicle body 28, and a third inlet 230C is positioned near a second wheel well 262B of the vehicle body 28. A door 264 may be selectively moved to open or close at least the second inlet 230B and the third inlet 230C, in a further non-limiting embodiment.

The conduit 222 further includes an outlet 232. The airflow F may be expelled from the conduit 222 through the outlet 232 after energy has been extracted from the airflow F by the turbine 224. In a non-limiting embodiment, the outlet 232 is disposed at a rear of the vehicle body 28. However, other outlet locations are also contemplated.

Airflow F entering into each branch 260 mixes with airflow F from other branches at a junction 268 prior to passing to the turbine 224. A stator 236 of the turbine 224 controls the speed and direction of the airflow F, and the rotor 238 rotates to extract energy from the airflow F. The energy extracted from the airflow F by the rotor 238 drives the electrical generator 226 for generating electricity.

A control system 242 is adapted to activate/deactivate the regenerative air brake system 220. In a non-limiting embodiment, the control system 242 activates the regenerative air brake system 220 if the friction braking system 18 (see FIG. 1) of the vehicle 10 has been activated and deactivates the regenerative air brake system 220 if the friction braking system 18 has been deactivated.

FIG. 5, with continued reference to FIGS. 1-4, schematically illustrates a control strategy 300 for determining whether to activate the regenerative air brake system 20. Although the exemplary control strategy 300 is described with reference to the air brake system 20 of FIG. 2, it is equally applicable to the regenerative air brake systems 120, 220 of FIGS. 3 and 4, respectively. In a non-limiting embodiment, the control system 42 of the regenerative air brake system 20 is programmed with one or more algorithms adapted to execute the exemplary control strategy 300, or any other control strategy. In another non-limiting embodiment, the control strategy 300 is stored as executable instructions in the non-transitory memory 48 of the control module 44 of the control system 42.

The control strategy 300 begins at block 302. At block 304, the control strategy 300 determines whether a braking event, or vehicle deceleration, has been requested. Braking events occur when the friction braking system 18 has been actuated to begin decelerating the vehicle 10. In a non-limiting embodiment, the control system 42 of the regenerative air brake system 20 detects the braking event by analyzing the pedal position signal S1 received from the brake pedal 50. The brake pedal 50 thus directly controls activation of the friction braking system 18 and indirectly controls activation of the regenerative air brake system 20.

The control strategy 300 proceeds to block 306 if a braking event has been detected at block 304. At this block, the control system 42 may undertake a series of system analyses for determining whether or not to activate the regenerative air brake system 20. In a first non-limiting embodiment, the control system 42 compares a requested deceleration rate, which can be derived from the pedal position signal S1, to a threshold deceleration rate to determine whether to activate the regenerative air brake system 20. In another non-limiting embodiment, the control system 42 compares a current vehicle speed to a threshold vehicle speed to determine whether to activate the regenerative air brake system 20. In yet another non-limiting embodiment, the control system 42 estimates an amount of airflow F passing through the conduit 22 to determine whether to activate the regenerative air brake system 20. The amount of airflow F passing through the conduit 22 may be inferred based on feedback from a tachometer of the turbine 24, based on feedback from pressure sensors positioned within the conduit 22 and which provide an estimate of the density of the airflow F, or based on inferred ambient temperatures which provide an estimate of the density of the airflow F. The control system 42 may analyze one or more of the deceleration rate, the current vehicle speed, and the estimate of the airflow F passing through the conduit 22 when determining whether or not to activate the regenerative air brake system 20.

Based on the system analyses described above, the control strategy 300 determines whether the regenerative air brake system 20 would be effective to either assist in decelerating the vehicle 10 or to generate electricity at block 308. If YES, the control strategy 300 activates the regenerative air brake system 20 at block 310, and thus begins extracting energy from the airflow F with the rotor 38 of the turbine 24 to power the electrical generator 26. As part of this activation, the control strategy 300 may also determine how much of the capacity (between 0% and 100%) of the regenerative air brake system 20 should be utilized. This determination may again be based on series of system analyses associated with block 306. In a non-limiting embodiment, the capacity may be determined using one or more look-up tables stored in the non-transitory memory 48 of the control system 42.

In further non-limiting embodiments, activation and deactivation of the regenerative air brake system 20 may be controlled as follows. The resistance provided by the regenerative air brake system 20 depends on the energy extracted from the airflow F, which is first extracted by the turbine 24 and then mechanically transferred to the electrical generator 26. The resistance provided by the electrical generator 26, which translates to the resistance to the airflow F by the turbine 24, is directly related to the electrical current generated. Therefore, the regenerative air brake system 20 can be activated or deactivated by having the control system 42 modulate the generated current. While the regenerative air brake system 20 is deactivated, the electrical generator 26 is, in essence, disconnected, and the rotor 38 spins freely. Upon activation of the regenerative air brake system 20, the control system 42 engages the electrical generator 26, and as the current is generated the electrical generator 26, and therefore the turbine 24, will resist the airflow F and brake the vehicle 10 as it extracts energy from the airflow F.

In a first non-limiting embodiment, the control system 42 uses a form of signal modulation to regulate the current produced by the electrical generator 26. The control system 42 thus may vary the proportion of braking capacity that is requested from the regenerative air brake system 20 from 0% to 100%. The signal modulation strategy may utilize electrical relays, such as a pulse-width modulation methodology. In another non-limiting embodiment, the control system 42 uses an electrical relay to connect and disconnect the electrical generator 26 in accordance with activation and deactivation of the regenerative air brake system 20. In yet another non-limiting embodiment, the turbine 24 and the electrical generator 26 may be mechanically connected and disconnected in accordance with the activation and deactivation of the regenerative air brake system 20. Various mechanical components such as clutches, gears, etc. may be used to mechanically connect and disconnect the electrical generator 26.

The regenerative air brake system 20 is deactivated during non-braking events. Once deactivated, the control strategy 300 may return to block 302.

The regenerative air brake systems of this disclosure reduce the load on the vehicle's friction braking system and increase the amount of energy that can be reclaimed during vehicle decelerations. The energy reclaimed during the braking events helps compensate for energy that is otherwise lost to the environment (e.g., as waste heat) as the vehicle decelerates. The regenerative air brake systems are especially effective at high speeds when sudden deceleration is necessary.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A vehicle, comprising:
a vehicle body;
a regenerative air brake system disposed inside said vehicle body and including:
a conduit;
a turbine positioned in said conduit; and
an electrical generator operatively connected to said turbine and positioned remotely from said conduit.

2. The vehicle as recited in claim 1, wherein said conduit includes an inlet at a front of said vehicle body and an outlet at a rear of said vehicle body.

3. The vehicle as recited in claim 1, wherein said conduit at least partially extends through an engine compartment of said vehicle body.

4. The vehicle as recited in claim 1, wherein said conduit at least partially extends through a chassis of said vehicle body.

5. The vehicle as recited in claim 1, wherein said conduit includes a branch having an inlet, and a door is movable to open and close said inlet.

6. The vehicle as recited in claim 5, wherein said inlet is located near a wheel well of said vehicle body.

7. The vehicle as recited in claim 5, comprising an actuator configured to move said door between a first position and a second position to open and close said inlet.

8. The vehicle as recited in claim 1, wherein said conduit includes a first branch having a first inlet and a second branch having a second inlet, and said first branch and said second branch meet at a junction of said conduit, said junction upstream from said turbine.

9. The vehicle as recited in claim 1, wherein said turbine includes a stator and a rotor.

10. The vehicle as recited in claim 1, wherein said electrical generator feeds electricity to an electrical system of said vehicle.

11. The vehicle as recited in claim 1, comprising a friction braking system, and said regenerative air brake system and said friction braking system cooperate to decelerate said vehicle.

12. The vehicle as recited in claim 1, comprising a control system adapted to activate said regenerative air brake system during vehicle deceleration.

13. A method, comprising:
activating a regenerative air brake system of a moving vehicle during vehicle braking events to assist in decelerating the moving vehicle.

14. The method as recited in claim 13, comprising activating the regenerative air brake system if a requested deceleration rate exceeds a threshold deceleration rate.

15. The method as recited in claim 13, comprising activating the regenerative air brake system if a current vehicle speed exceeds a threshold vehicle speed.

16. The method as recited in claim 13, comprising activating the regenerative air brake system if an inferred amount of airflow passing through the regenerative air brake system exceeds a threshold amount of airflow.

17. The method as recited in claim 13, wherein the vehicle braking events occur when a friction braking system of the moving vehicle has been activated.

18. The method as recited in claim 13, comprising:
utilizing a turbine to extract energy from airflow communicated through a conduit of the regenerative air brake system; and
powering an electrical generator using the energy extracted from the airflow.

19. The method as recited in claim 18, comprising:
opening a door at an inlet of the conduit to allow the airflow to enter the conduit.

20. The method as recited in claim 13, comprising:
deactivating the regenerative air brake system during non-braking events.
